(19) United States
(12) Patent Application Publication
(10) Pub. No.: US 2020/0137550 A1
(43) Pub. Date: Apr. 30, 2020

(54) FAST INITIAL LINK SETUP (FILS) PROTOCOL TO SUPPORT MULTIPLE BASIC SERVICES SETS

(71) Applicant: QUALCOMM Incorporated, San Diego, CA (US)

(72) Inventors: Abhishek Pramod Patil, San Diego, CA (US); George Cherian, San Diego, CA (US); Jouni Kalevi Malinen, Tuusula (FI); Alfred Asterjadhi, San Diego, CA (US)

(21) Appl. No.: 16/667,630

(22) Filed: Oct. 29, 2019

Related U.S. Application Data
(60) Provisional application No. 62/752,282, filed on Oct. 29, 2018.

(51) Int. Cl. H04W 8/00; H04W 48/10; H04W 48/16; H04W 80/02; H04W 76/11; H04W 48/20; H04W 72/04

(52) U.S. Cl. CPC H04W 8/005; H04W 48/10; H04W 48/16; H04W 84/12; H04W 76/11; H04W 48/20; H04W 72/0406; H04W 80/02

(57) ABSTRACT

This disclosure provides systems, methods, and apparatus, including computer programs encoded on computer-readable media, to communicate discovery information regarding multiple basic service sets (BSSs) hosted at an apparatus. A group of BSSs having related basic service set identifiers (BSSIDs) may form a Multiple BSSID set. A first BSS may be referred to as having a transmitted BSSID (TxBSSID), while one or more other BSSs of the Multiple BSSID set may be referred to as having non-transmitted BSSIDs (NonTxBSSIDs). The apparatus can send discovery information for a station to determine the NonTxBSSIDs in addition to the TxBSSID. For example, the discovery information may be included in a fast-initial link setup (FILS) discovery (FD) frame that is sent between normal beacon times. This disclosure describes several ways to modify the FD frame to accommodate sending the discovery information for the Multiple BSSID set.

### CROSS-REFERENCE TO RELATED APPLICATIONS

This patent application claims priority to U.S. Provisional Patent Application No. 62/752,282, filed Oct. 29, 2018, entitled “FAST INITIAL LINK SETUP (FILS) PROTOCOL TO SUPPORT MULTIPLE BASIC SERVICES SETS,” and assigned to the assignee hereof. The disclosure of the prior application is considered part of and is incorporated by reference in this patent application.

### TECHNICAL FIELD

This disclosure relates to the field of network communication, and more particularly to wireless local area networks.

### DESCRIPTION OF THE RELATED TECHNOLOGY

A wireless local area network (WLAN) can enable wireless communication between WLAN devices. Each WLAN device may have a station (STA) interface that is an addressable entity that shares a wireless communication medium with other STAs. One or more of the WLAN devices (which may be referred to as an access point, AP) may establish the common service settings. An AP is a type of STA that performs a distribution system access function in the WLAN. The AP may provide a wireless coverage area used by one or more STAs. The basic building block of a WLAN is a Basic Service Set (BSS), which is managed by an AP. A BSS refers to one AP that has established service settings and one or more STAs that have successfully synchronized the service settings.

Multiple APs may be used within the same geographical area to support larger quantities of STAs or to separate traffic among groups of STAs. In the past, a single WLAN apparatus may have hosted only one BSS (associated with one AP). The BSS may be associated with a BSS identifier (BSSID). Recently, a single WLAN apparatus may be configured to host multiple BSSs (each BSS associated with a different virtual AP) from the same WLAN apparatus. Each BSS may be associated with a different BSS identifier (BSSID).

### SUMMARY

The systems, methods, and devices of this disclosure each have several innovative aspects, no single one of which is solely responsible for the desirable attributes disclosed herein.

Various innovative aspects of the subject matter described in this disclosure relate to a wireless local area network (WLAN) apparatus that operates multiple basic service sets (Multiple BSSs). The WLAN apparatus can send discovery information that can be used by any nearby stations (STAs) to determine a set having multiple BSS identifiers (Multiple BSSID set). In some implementations, a fast-initial link setup (FILS) discovery (FD) frame format can be modified to include the discovery information.

One innovative aspect of the subject matter described in this disclosure can be implemented as a method, an apparatus for a WLAN apparatus, a computer-readable storage medium, or other means for performing functions of a WLAN apparatus. The method, apparatus, computer-readable storage medium, or means may be configured to operate multiple basic service sets (BSSs) at the WLAN apparatus. Each of the BSSs may be identified by BSS identifiers (BSSIDs) and collectively the multiple BSSs may form a Multiple BSSID Set. A first BSS is identified as a transmitting BSSID (TxBSSID) of the Multiple BSSID Set and is configured to transmit one or more management frames that include elements for other BSSs of the Multiple BSSID Set. The other BSSs each identified as a non-transmitting BSSID (NonTxBSSID). The method, apparatus, computer-readable storage medium, or means may be configured to transmit a first discovery report via the first BSS. The first discovery report may include discovery information regarding at least one NonTxBSSID of the Multiple BSSID Set.

In some implementations, the multiple BSSs of the Multiple BSSID Set use a common operating class, channel, channel access function, and antenna connector at the WLAN apparatus. The multiple BSSs are identified by BSSIDs that have a common portion.

In some implementations, the first discovery report includes the TxBSSID of the first BSS as a source of the first discovery report. The first discovery report may include NonTxBSSIDs for each of the other BSSIDs in the Multiple BSSID Set.

In some implementations, the first discovery report includes a first set of NonTxBSSIDs of the Multiple BSSID Set. In some implementations, the method, apparatus, computer-readable storage medium, or means may be configured to transmit a second discovery report via the first VAP, wherein the second discovery report includes a second set of NonTxBSSIDs of the Multiple BSSID Set.

In some implementations, the first discovery report is included in a new information element of a fast-initial link setup (FILS) discovery (FD) frame defined for a FILS protocol.

In some implementations, the first discovery report is included in a reduced neighbor report (RNR) element of a management frame.

In some implementations, the RNR element is included in a fast-initial link setup (FILS) discovery (FD) frame that conforms to a FILS protocol of the WLAN, a Beacon frame, or Probe Response frame.

In some implementations, the RNR element includes a first field to indicate a format of the RNR element, wherein the first field is populated with a first value when the RNR element is formatted with a first format to include information regarding a neighbor AP. In some implementations, the first field is populated with a second value when the RNR element is formatted with a second format to include information regarding the Multiple BSSID Set.

In some implementations, the first format and the second format include different field definitions for one or more other fields in the RNR element.

In some implementations, the first discovery report includes an indicator to whether the discovery information includes a complete list or a partial list of NonTXBSSIDs in the Multiple BSSID Set.

In some implementations, the first discovery report includes at least one short service set identifier (Short SSID), the Short SSID being a fixed length hash of a service set identifier (SSID).

In some implementations, the discovery information includes a count of the multiple BSSs associated with a Multiple BSSID Set.

In some implementations, the discovery information includes a bitmap index that represents which BSSs of a Multiple BSSID Set are being hosted at the WLAN apparatus.

In some implementations, the bitmap index and a BSS identifier (BSSID) are usable by a station (STA) to determine a list of BSSIDS associated with the Multiple BSSID Set.

In some implementations, the first discovery report includes a maximum basic service set identifier (MaxBSSID) indicator associated with the Multiple BSSID Set the MaxBSSID indicator for indicating a maximum quantity of BSSIDs in the Multiple BSSID Set.

Another innovative aspect of the subject matter described in this disclosure can be implemented as a method, an apparatus for a WLAN apparatus, a computer-readable storage medium, or other means for performing functions of a WLAN apparatus. The method, apparatus, computer-readable storage medium, or means may be configured to receive a first discovery report from the WLAN apparatus that operates multiple basic service sets (BSSs). Each of the BSSs are identified by BSS identifiers (BSSIDs) and collectively the multiple BSSs form a Multiple BSSID Set. A first BSS may be identified as a transmitting BSSID (TxBSSID) of the Multiple BSSID Set, the other BSSs each identified by a non-transmitting BSSID (NonTxBSSID). The method, apparatus, computer-readable storage medium, or means may be configured to obtain, from the first discovery report, discovery information regarding one or more other BSSs in the Multiple BSSID Set. The method, apparatus, computer-readable storage medium, or means may be configured to determine, from the discovery information, a list of (NonTxBSSIDs for at least a subset of the one or more other BSSs hosted by the WLAN apparatus.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 depicts a system diagram of an example wireless local area network (WLAN) apparatus operating multiple basic service sets (Multiple BSSs).

FIG. 2 depicts a system diagram of an example WLAN using a fast-initial link setup (FILS) protocol to communicate discovery information regarding Multiple BSSs.

FIG. 3 depicts an example flowchart for signaling a first discovery frame regarding Multiple BSSs.

FIG. 4 depicts a conceptual diagram of an example FILS discovery (FD) frame format showing example message elements that can be used to communicate discovery information about a Multiple BSSID set.

FIG. 5 depicts a traditional FILS discovery information field of an FD frame format.

FIG. 6 depicts an example of a FILS discovery information field of an FD frame format that includes discovery information about a Multiple BSSID set.

FIG. 7 depicts example formats of discovery information about a Multiple BSSID set that can be included in an FD frame format.

FIG. 8 depicts an example of a FILS discovery information field with overloaded subfields to include discovery information about a Multiple BSSID set.

FIG. 9 depicts an example of a new information element formatted for discovery information regarding Multiple BSSs for use in an FD frame format.

FIG. 10 depicts an example of a reduced neighbor report (RNR) element of an FD frame format that includes discovery information about a Multiple BSSID set.

FIG. 11 depicts another example of an RNR element of an FD frame format that includes discovery information about a Multiple BSSID set.

FIG. 12 depicts an example bitmap that indicates both the quantity and index of BSSIDs in a multiple BSSID set.

FIG. 13 depicts an example flowchart for a station (STA) receiving a discovery frame that includes discovery information regarding multiple BSSIDs.

FIG. 14 shows a block diagram of an example electronic device for implementing aspects of this disclosure.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The examples in this disclosure are based on wireless local area network (WLAN) communication according to the Institute of Electrical and Electronics Engineers (IEEE) 802.11 wireless standards. However, the described implementations may be implemented in any device, system or network that is capable of transmitting and receiving RF signals according to any wireless communication standard, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, such as a system utilizing 3G, 4G, 5G, 6G, or further implementations thereof, technology.

A WLAN in a home, apartment, business, or other area may include one or more WLAN devices. Each WLAN device may have a station (STA) interface which is an addressable entity that shares a wireless communication medium with other STAs. An access point (AP) is a type of STA that performs a distribution system access function in the WLAN. STAs in the network can establish a wireless association (also referred to as a wireless link, wireless connection, or the like) with an AP to access the broadband network via the gateway device. The basic building block of a WLAN conforming to the IEEE 802.11 family of standards is a Basic Service Set (BSS), which is managed by an AP. Typically, each AP would transmit management frames (such as Beacon Frames, Probe Response Frames, or the like) to provide information about its BSS to any STAs in the vicinity of the AP.

A WLAN apparatus may operate multiple virtual APs (VAPs), and each VAP may be associated with a different BSS. Operating a virtual AP for a BSS also may be referred to as hosting the BSS. Other terms may be used to represent the existence of a BSS (and corresponding VAP) at the WLAN apparatus, including having an active BSS, instantiating the BSS, or the like. Each BSS is associated with a different BSS identifier (BSSID). Rather than each VAP transmitting separate management frames to indicate its respective BSSID, it is possible for a first VAP to transmit management information regarding multiple BSSs. Multiple BSSID capability may refer to a capability of a WLAN apparatus to advertise management information for multiple BSSIDs using a single management frame (such as a Beacon Frame or Probe Response Frame). This has the advantage of reducing network overhead while enabling a WLAN apparatus to host different BSSs (such as for traffic separation). In some implementations, the WLAN apparatus also may indicate buffered frames for these multiple BSSIDs using a single traffic indication map (TIM) element in a single management frame. For example, the first VAP (for a first BSS) may be designated as a primary source for management frames that include management information regarding multiple BSSs, including one or more other BSSs in operation (being hosted) at the WLAN apparatus. Together, the multiple BSSIDs that are included in the single management frame signaling may be referred to as a Multiple BSSID set. The BSSID of the first VAP may be referred to as the “transmitted BSSID” (or TxBSSID). In a Multiple BSSID set, there may be only one TxBSSID. The BSSID of another VAP belonging to a Multiple BSSID set may be referred to as a “nontransmitted BSSID” (or NonTxBSSID). There may be multiple NonTxBSSIDs in the Multiple BSSID Set.

A management frame (from a first VAP corresponding to the transmitted BSSID) may include identifiers (such as NonTxBSSIDs) or other profile information regarding the other BSSs in the Multiple BSSID set. A STA may receive the management frame to learn about the transmitted BSSID and any of the other BSSs identified in the management frame. In additional to traditional management frames, the IEEE has developed a fast-initial link setup (FILS) protocol to improve network discovery and setup times. Among several frame formats, the FILS protocol specifies FILS discovery (FD) frames that are broadcast in a wireless coverage area and which may occur more frequently than traditional management frames. For example, several FD frames may be broadcast between successive Beacon frames. Therefore, the FD frames may be a faster technique to provide information about networks available for a STA to join. It is desirable for the FILS protocol to support Multiple BSSID capability. Current frame formats defined for the FILS protocol do not support the transmission of discovery information regarding NonTxBSSIDs of a Multiple BSSID set.

In accordance with this disclosure, a discovery frame (such as an FD frame format for the FILS protocol) can include discovery information regarding NonTxBSSIDs in a Multiple BSSID set. Several techniques are described which can be used to include the discovery information in the discovery frame. For example, a frame format for the discovery frame may be modified to support Multiple BSSID capability.

In some implementations, the frame format for an FD frame may be modified to include a new subfield in a FILS Discovery Information field. An indicator (such as a bit indicator) in the control field can be used to indicate that the additional NonTxBSSID information is present. There may be various ways to include the additional NonTxBSSID information, and this disclosure includes several examples. For example, a control field could indicate a maximum BSSID (MaxBSSID) indicator, the quantity of SSIDs in a list, the quantity of active BSSIDs, or the like. In some implementations, a compressed control field could use 3 bits to indicate the MaxBSSID indicator and 5 bits to indicate how many SSIDs are active. The discovery information may include BSSIDs, service set identifiers (SSIDs), a short SSID (such as a 4 octet hash of the SSID), or other identifiers usable by a STA to determine a list of BSSIDs associated with the Multiple BSSID set.

In some implementations, the frame format for an FD frame may be modified to repurpose an address subfield in a FILS Discovery Information field. For example, an address field that typically only carries one SSID or Short SSID (referred to as the SSID/Short SSID field) could be modified to support a list of multiple identifiers (such a list of short SSIDs). An indicator in the control subfield or the FD capability subfield could be used to indicate that the SSID/Short SSID field has been repurposed to include a list of identifiers. In some implementations, when the SSID/Short SSID field has been repurposed to include a list of identifiers, another field that would otherwise relate to the SSID/Short SSID field could also be repurposed. For example, the Short SSID indicator subfield in the control field could be used to indicate whether the list of identifiers in the SSID/Short SSID field is a complete list or a partial list of the Multiple BSSID set.

In some implementations, a reduced neighbor report (RNR) element of the FD frame format may be modified to include discovery information regarding the Multiple BSSID set. For example, the RNR element could be used to include identifiers (such as the NonTxBSSIDs) even though those identifiers are for BSSs that are hosted by the same WLAN apparatus and share some common settings as the TxBSSID. An indicator (such as a bit) in the header of the RNR element could indicate that the RNR element is for a NonTxBSSID of the Multiple BSSID set. In some implementations, the RNR element may be reduced in size by omitting one or more redundant fields of the RNR element (operating class, channel, TBTT offset, or the like) that the NonTxBSSID shares with the TxBSSID.

In some implementations, the FILS protocol could be modified to define a new information element to include information about a NonTxBSSID in the FD frame format. For example, the new information element could be an optional element (with element identifier) that could be defined with a format optimized for information regarding a Multiple BSSID set. A control field in the new information element could indicate the type of identifiers (such as a BSSID, SSID, short SSID, index, or the like) that is included in the new information element. An indicator could be used to indicate whether the list of identifiers in the FD frame is a complete list or partial list of the Multiple BSSID Set.

Particular implementations of the subject matter described in this disclosure can be implemented to realize one or more of the following potential advantages. An FD frame can signal discovery information about a Multiple BSSID set (including information regarding one or more NonTxBSSIDs). Doing so would reduce the number of FD frames in the wireless medium while informing STAs regarding the other BSSs available from the WLAN apparatus. Faster discovery and association can improve service to the STA and reduce overhead on the wireless channel.

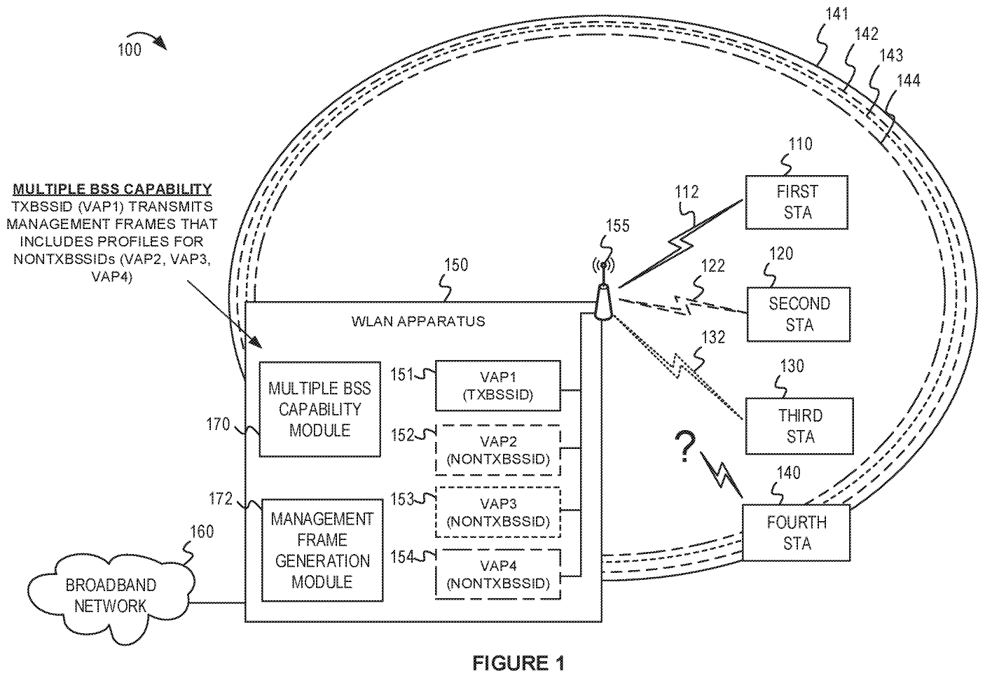

FIG. 1 depicts a system diagram of an example WLAN apparatus operating Multiple BSSs. The system diagram 100 includes a WLAN apparatus 150 that is communicatively coupled to a broadband network 160. The WLAN apparatus 150 may be communicatively coupled (or co-located) with a gateway device (not shown). A gateway device, such as a modem or router, may provide access to the broadband network 160. For example, the gateway device can couple to the broadband network through a cable, a fiber optic, a powerline, or DSL network connection.

The WLAN apparatus 150 is operating multiple VAPs, such as a first VAP 151, a second VAP 152, a third VAP 153, and a fourth VAP 154. The first VAP 151 is providing a first coverage area 141. Similarly, the second VAP 152 provides a second coverage area 142, the third VAP 153 provides a third coverage area 143, and the fourth VAP 154 provides a fourth coverage area 144. For illustration purposes, the first coverage area 141, second coverage area 142, third coverage area 143, and fourth coverage area 144 are shown as different size ovals in the diagram. However, the sizes of the coverage areas may be similar to each other and the shapes of the coverage areas may vary as a result of environmental obstructions or interference. The WLAN apparatus 150 may have one or more antennas 155. In some implementations, the VAPs 151, 152, 153 and 154 may share the same one or more antennas 155. The WLAN apparatus may utilize more than one antenna. For example, the WLAN apparatus may utilize multiple-input-multiple-output (MIMO) communication in which multiple antennas transmit wireless signals.

In FIG. 1, each of the VAPs 151, 152, 153 and 154 are associated with different BSSs. Each BSS is associated with a different BSSIDs. The Multiple BSSs may use a common wireless channel configuration (such as operating class, channel, channel access function) at the WLAN apparatus. The wireless channel configuration may utilize a portion of a frequency band (such as a 2.4 GHz frequency band, a 5 GHz frequency band, etc.). The BSSIDs of the Multiple BSSs may have a common portion (such as the same 48 most significant bits). The BSSIDs of the Multiple BSSs form a Multiple BSSID set. Although the BSSs share some common settings, each BSS maintains different wireless associations with different client stations. A STA can establish a wireless association (also referred to as a wireless link, wireless connection, or the like) with a VAP to access the broadband network via the WLAN apparatus 150. In FIG. 1, a first STA 110 has a first wireless association 112 with a first BSSID (corresponding to the first VAP 151). A second STA 120 has a second wireless association 122 with a second BSSID (corresponding to the second VAP 152). A third STA 130 has a third wireless association 132 with a third BSSID (corresponding to the third VAP 153).

The first BSS (managed by the first VAP 151) is identified by a first identifier (TxBSSID) that identifies a source of management frames sent on behalf of the Multiple BSSID set. The other BSSs (managed by the other VAPs 152, 153 and 154) are identified by other BSS identifiers (NonTxBSSIDs) that are advertised by the first VAP 151. Among all the VAPs in a Multiple BSSID set, only the first VAP corresponding to the TxBSSID may transmit particular management frames (such as a Beacon Frame, Probe Response, or the like) on behalf of the Multiple BSSID set. In some implementations, the management frame may include an indication, such as a “MaxBSSID indicator,” to signal a maximum quantity of contiguously numbered BSSIDs that could belong to a Multiple BSSID set. The MaxBSSID indicator may carry a value n that indicates that the Multiple BSSID set may include up to 2\hat{ }n BSSIDs. For example, a MaxBSSID indicator having a value of four (4) may signal that a Multiple BSSID Set may include up to sixteen (16) BSSIDs. The Multiple BSSID Set may include less than sixteen BSSIDs.

Returning to the example in FIG. 1, a fourth STA 140 may enter the vicinity of the WLAN apparatus 150. The fourth STA 140 may observe a discovery frame (such as a FILS discovery frame) to determine the BSSID(s) available from the WLAN apparatus 150. In accordance with aspects of this disclosure, the discovery frame may indicate some or all of the NonTxBSSIDs of the other BSSs (corresponding to VAPs 152, 153 and 154) being hosted by the WLAN apparatus 150.

In some implementations, the WLAN apparatus 150 may have a Multiple BSS Capability module 170 and a management frame generation module 172 to perform some or all of the operations described herein. For example, the Multiple BSS Capability module 170 may coordinate with the one or more VAPs and may store the BSSIDs for the Multiple BSSID Set. The management frame generation module 172 may generate the management frames (including FILS discovery frames) for the Multiple BSSID Set.

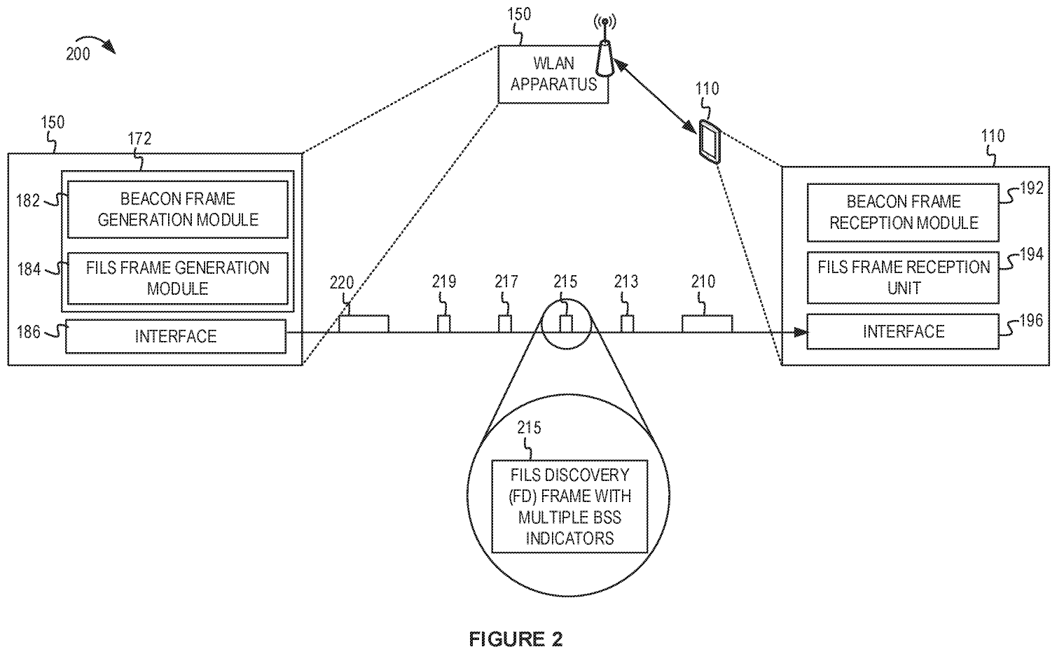

FIG. 2 depicts a system diagram of an example WLAN using a FILS protocol to communicate discovery information regarding Multiple BSSs. The system 200 includes a WLAN apparatus 150 that implements Multiple BSSID set capability. A first STA 110 is in the vicinity of the WLAN apparatus 150. The WLAN apparatus 150 may include a management frame generation module 172. For example, the management frame generation module 172 may include a beacon frame generation module 182 and a FILS frame generation module 184. A Beacon Frame is one example of a management frame that the management frame generation module 172 may prepare on behalf of a Multiple BSSID set. The FILS protocol specifies frame formats that are also considered management frames. For example, a FILS discovery frame may be output by the FILS frame generation module 184 for transmission via an interface 186 of the WLAN apparatus 150. For example, the interface 186 may be coupled to one or more antennas (not shown) of the WLAN apparatus 150.

The WLAN apparatus 150 may transmit several FD frames 213, 215, 217, and 219 in the time period between two Beacon frames 210, 220. For example, the FD frames may be short broadcasts with a smaller format than the Beacon frames 210, 220. While the Beacon frame format may include identifiers for the Multiple BSSID set, a traditional FD frame format specified by the FILS protocol does not include identifiers for the Multiple BSSID set. In accordance with this disclosure, the FD frame format may be modified to include discovery information regarding the Multiple BSSID set.

The first STA 110 may include a beacon frame reception module 192, a FILS frame reception module 194, and an interface 196. For example, the interface 196 may receive the broadcast FD frame 215 and send it to the FILS frame reception module 194. The FILS frame reception module 194 may process the FD frame in accordance with one or more of the frame format modifications described in this disclosure.

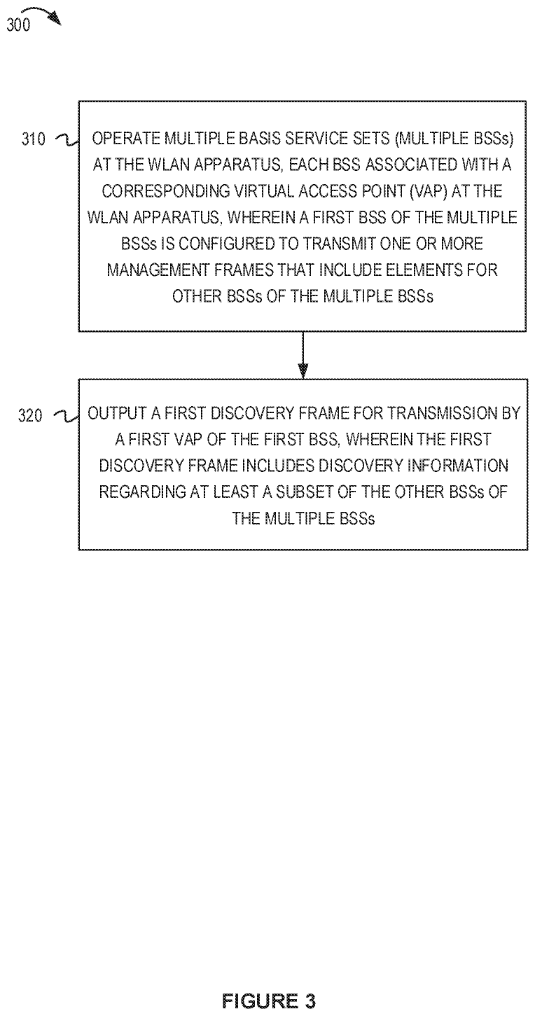

FIG. 3 depicts an example flowchart for signaling a first discovery frame regarding Multiple BSSs. The flowchart 300 begins at block 310. At block 310, a WLAN apparatus may operate Multiple BSSs at the WLAN apparatus. Each BSS may be associated with a corresponding VAP at the WLAN apparatus. A first BSS of the Multiple BSSs may be configured to transmit one or more management frames that include elements for other BSSs of the Multiple BSSs. For example, the first BSS may be designated as the TxBSSID, while the other BSSs may be designated as NonTxBSSIDs.

At block 320, the WLAN apparatus may output a first discovery frame for transmission by a first VAP of the first BSS. The first discovery frame may include discovery information regarding at least one of the other BSSs of the Multiple BSSs. For example, the first discovery frame may include a list of NonTxBSSIDs. In some implementations, the first discovery frame may include a partial list of NonTxBSSIDs. An indicator in the first discovery frame may indicate whether the list is a partial list or a complete list. In some implementations, the first discovery frame may include short SSIDs or SSIDs (rather than a full BSSID) associated with the NonTxBSSIDs.

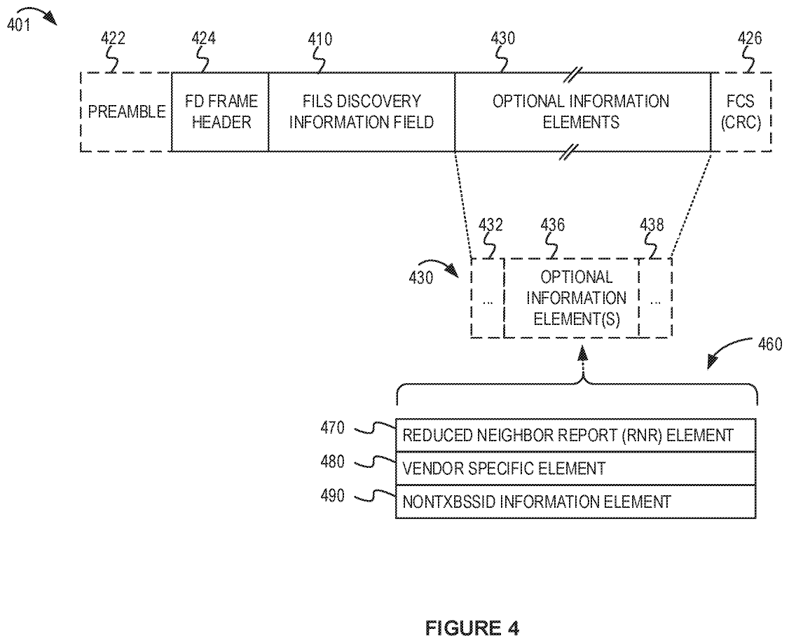

FIGS. 4-10 describe several example frame formats that can be used to include discovery information regarding a Multiple BSSID set. The example frame formats and indicator locations are merely examples. In some implementations, a different discovery frame format or different specified values may be used. In some other implementations, the use of the indicator may be specified in a standard specification. For example, some implementations of the indicator may be mandated for IEEE 802.11ax devices, IEEE 802.11-be, or later developed wireless communication standards. In some other implementations, the indicator may be optional or may be disregarded by legacy devices that do not support newer standard specifications.

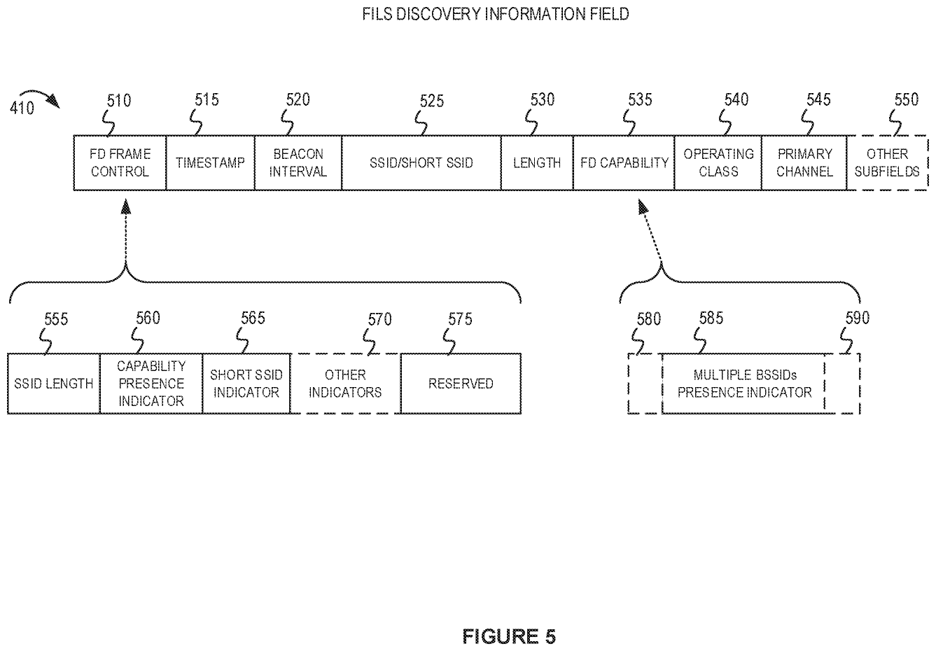

FIG. 4 depicts a conceptual diagram of an example FD frame format 401 showing example message elements that can be used to communicate discovery information about a Multiple BSSID set. For example, the example FD frame format 401 may be sent via an interface of a WLAN apparatus. The example FD frame format 401 may include a preamble 422, an FD frame header 424, a FILS discovery information field 410, zero or more optional information elements 430, and a frame check sequence (FCS) 426. The preamble 422 may include one or more bits to establish synchronization. For example, the preamble 422 may include a legacy short training field (L-STF), a legacy long training field (L-LTF), a legacy signaling field (L-SIG), or the like. The preamble 422 may be used, for example, when a dedicated discovery channel uses a listen-before-talk, contention-based access, or carrier sense access. In some implementations, if the wireless channel uses a scheduled timeslot for transmission, the preamble 422 may be omitted. The FD frame header 424 may include a field that indicates the frame format is a FILS discovery frame. For example, the FD frame header 424 may include a Category field and a public action field that identifies the frame format of the message. The format of the FILS discovery information field 410 is further described in FIG. 5.

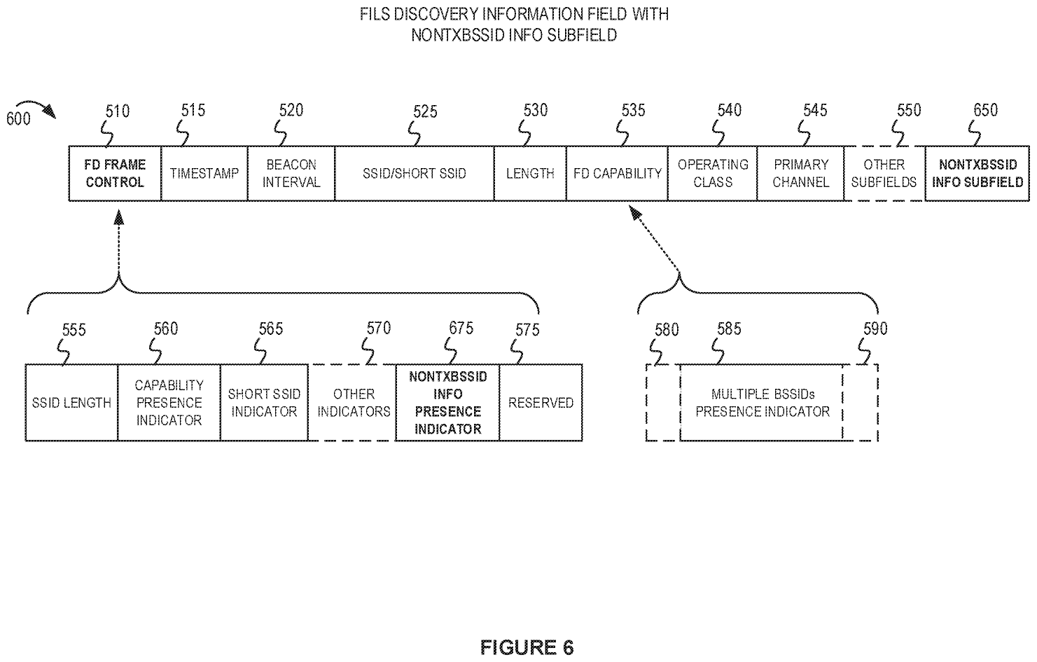

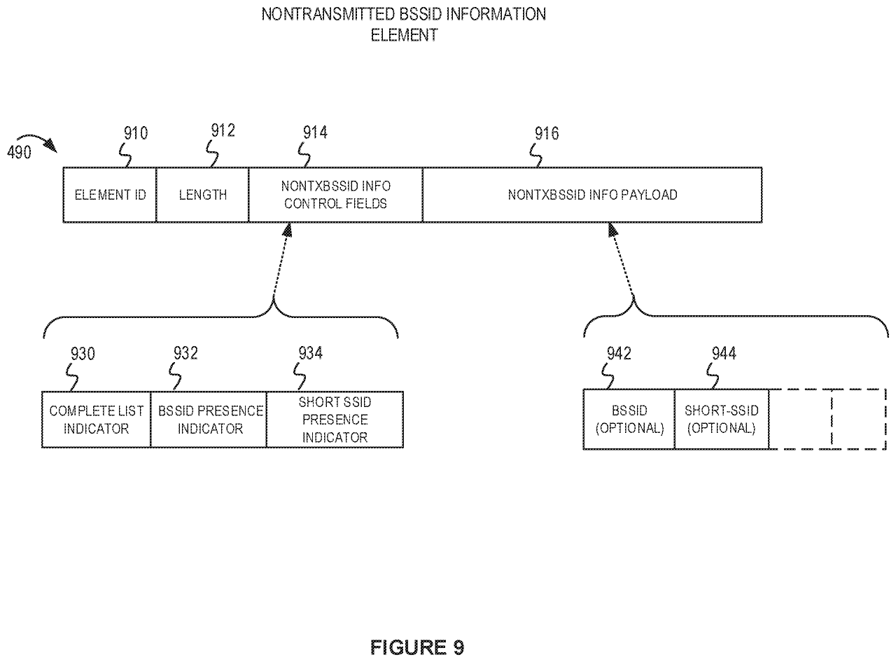

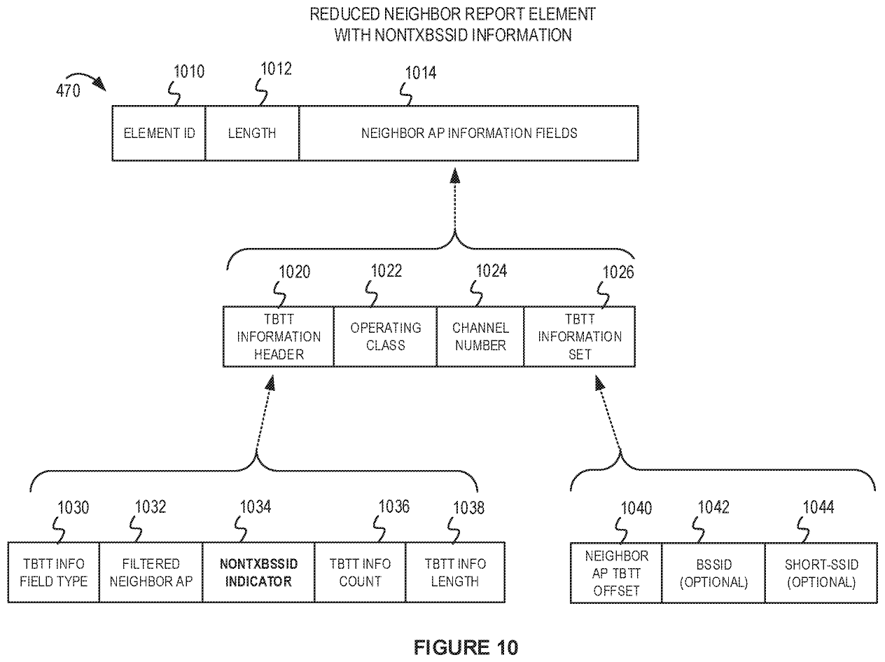

There may be many ways to include discovery information for NonTXBSSIDs in the example FD frame format 401. For example, the discovery information may be included in the FILS discovery information field 410 or in one of the optional information elements 430. FIGS. 6-8 includes examples of how the discovery information may be included in the FILS discovery information field 410. In some implementations, the discovery information may be included in one of the optional information elements 430. The optional information elements 430 may be organized in a particular order of information elements 432, 436, and 438. A non-exhaustive list of example information elements 460 is illustrated in FIG. 4, including a reduced neighbor report (RNR) element 470, a vendor-specific element 480, and a new information element (such a NonTXBSSID information element 490). FIG. 9 includes examples of how the discovery information may be included in the RNR element 470. FIG. 10 includes examples of how the discovery information may be included in a vendor-specific element 480 or a new information element (such the NonTXBSSID information element 490).

FIG. 5 depicts a traditional FILS discovery information field 410 of an FD frame format. The FILS discovery information field 410 may include an FD frame control subfield 510, a timestamp 515, a beacon interval subfield 520, an SSID/Short SSID subfield 525, a length subfield 530, an FD capability subfield 535, an operating class 540, a primary channel 545 and other subfields 550. The FD frame control subfield 510 may include values or indicators (such as bits) that describe how the rest of the FILS discovery information field 410 is structured. For example, an SSID length value 555 may indicate the length of the SSID/short SSID subfield 525. A capability presence indicator 560 (for example a bit to indicate 1 (or True) or 0 (or False)) may indicate whether the FD capability subfield 535 is included in the FILS discovery information field 410. A short SSID indicator 565 may indicate whether the SSID/short SSID subfield 525 includes a variable length SSID or includes a fixed length short SSID. For example, the short SSID may be a 4-octet identifier that is a hash value of the full SSID. There may be other indicators 570 defined in the FD frame control subfield 510. In addition, there may be some bits that are reserved 575, some of which may be used to define a new indicator in the FD frame control subfield 510. The FD capability subfield 535 includes several indicators 580, 585, 590, including the Multiple BSSIDs presence indicator 585. It is noted that while the Multiple BSSIDs presence indicator 585 is present in the traditional FILS discovery information field 410 of a traditional FD frame format, the traditional FD frame format does not include a way to signal identifiers for the Multiple BSSID set.

FIG. 6 depicts an example of a FILS discovery information field 600 of an FD frame format that includes discovery information about a Multiple BSSID set. The FILS discovery information field 600 has the same structure as the traditional FILS discovery information field 410, with the addition of a NonTxBSSID information subfield 650. One of the reserved bit positions of the reserved 575 bits may be redefined to represent a NonTxBSSID information presence indicator 675. When the NonTxBSSID information presence indicator 675 is set to a first value (such as “1”), then the FILS discovery information field 600 may include the NonTxBSSID information subfield 650. Conversely, when the NonTxBSSID information presence indicator 675 is set to a second value (such as “0”), then the FILS discovery information field 600 may not include the NonTxBSSID information subfield 650.

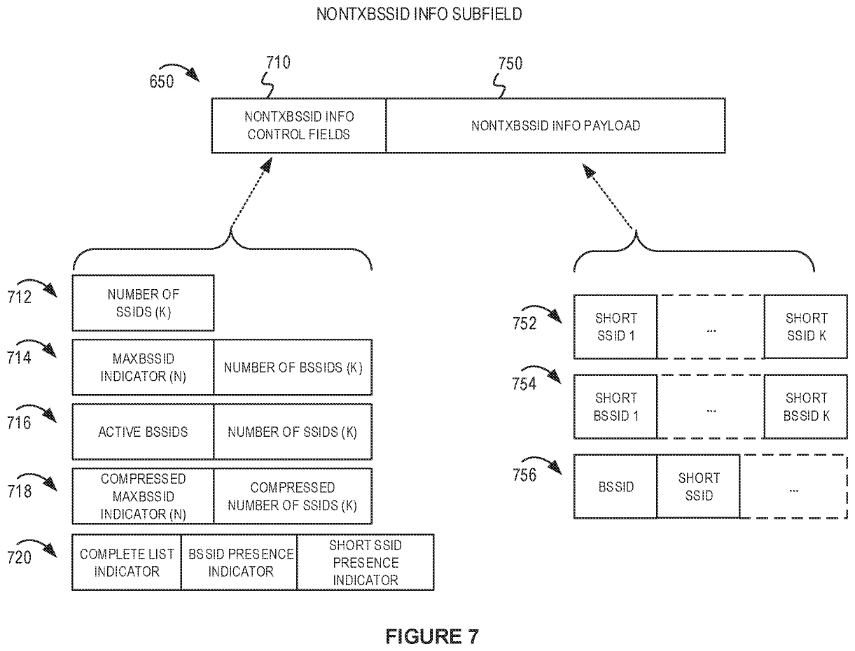

The format of the NonTxBSSID information subfield 650 may be defined in a variety of ways. For example, the NonTxBSSID information subfield 650 may include discovery information formatted according to one of the examples in FIG. 7.

FIG. 7 depicts example formats of discovery information about a Multiple BSSID set that can be included in an FD frame format. For example, the format may be used in the NonTxBSSID Information subfield 650 of FIG. 6. The NonTxBSSID information subfield 650 may include one or more NonTxBSSID information control fields 710 and a NonTxBSSID information payload 750. There may be different ways to define each of these fields.

Several example formats 712, 714, 716, 718, and 720 for the NonTxBSSID information control fields 710 are included in FIG. 7. A first example format 712 includes a field to indicate a number of SSIDs (k) included in the NonTxBSSID information payload 750. A second example format 714 includes a MaxBSSID indicator (n) and a number of BSSIDs (k). A third example format 716 includes a quantity of active BSSIDs and a number of SSIDs (k). A fourth example format 718 may be a compressed control field. For example, the compressed control field may include 3 bits to signal the MaxBSSID Indicator (n) and 5 bits to signal the number of SSIDs (k).

A fifth example format 720 may include more information about the structure of the NonTxBSSID information payload 750. For example, the example format 720 may include a complete list indicator (or a partial list indicator), a BSSID presence indicator (to indicate whether the payload includes a full BSSID), and a short SSID presence indicator (to indicate whether the payload includes a short SSID).

Several example formats 752, 754, and 756 for the NonTxBSSID information payload 750 are included in FIG. 7. A first example format 752 may include a list of short SSIDs. For example, each short SSID may be a 4-octet value. A second example format 754 may include a list of short BSSIDs. A third example 756 may include a BSSID and one or more short SSIDs.

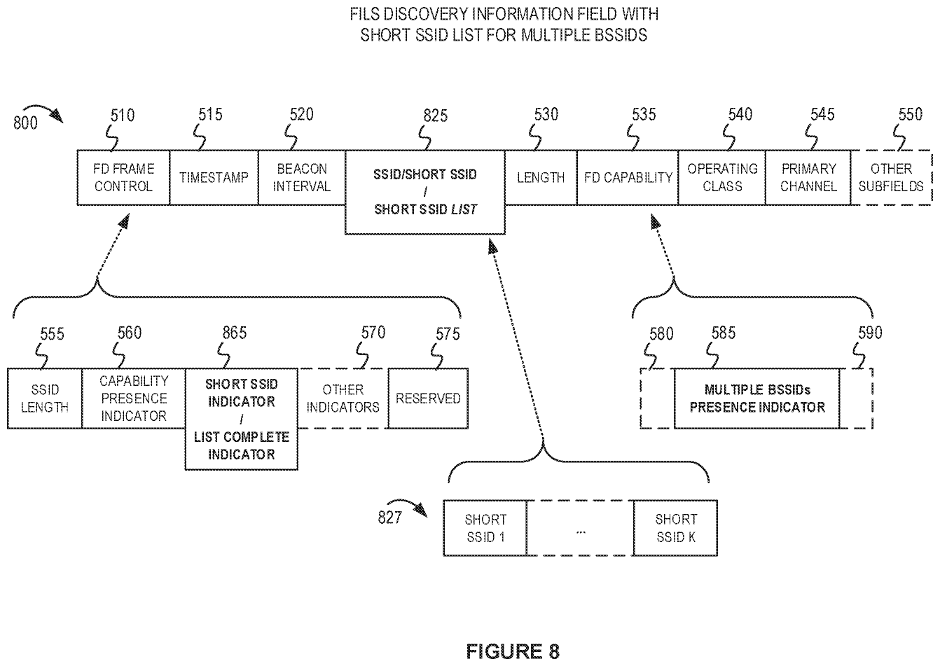

FIG. 8 depicts an example of a FILS discovery information field 800 with overloaded subfields to include discovery information about a Multiple BSSID set. The FILS discovery information field 800 has the same structure as the traditional FILS discovery information field 410. However, some of the fields have been repurposed (overloaded) to redefine the format. For example, when the Multiple BSSIDs presence indicator 585 has a first value (such as “1”), then the SSID/Short SSID subfield 825 may be redefined to include a list of SSIDs or Short SSIDs 827. Conversely, when the Multiple BSSIDs presence indicator 585 is set to a second value (such as “0”), then the SSID/Short SSID subfield 825 uses the traditional meaning (such as the SSID/short SSID subfield 525 of FIG. 5).

Further modifications to the traditional FILS discovery information field may be possible. For example, if the SSID/Short SSID subfield 825 is defined to use only short SSIDs in a list of short SSIDs 827 (when the Multiple BSSIDs presence indicator 585 is set), then the short SSID indicator 565 of FIG. 5 may no longer be relevant. Instead, that indicator (list complete indicator 865) could be redefined to specify whether the list of Short SSIDs 827 is a complete list or a partial list of the Multiple BSSID set.

FIG. 9 depicts an example of a new information element formatted for discovery information regarding Multiple BSSs for use in an FD frame format. For example, the new information element may be a NonTxBSSID information element 490. The NonTxBSSID information element 490 may include a unique element ID 910 that identifies the information element as having a particular format for NonTxBSSID information. The NonTxBSSID information element 490 also may have a length field 912, one or more NonTxBSSID information control fields 914, and a NonTxBSSID information payload 916. The one or more NonTxBSSID information control fields 914 and the NonTxBSSID information payload 916 may be similar to any combination of the example formats described in FIG. 7.

For example, the one or more NonTxBSSID information control fields 914 may include a complete list indicator 930, a BSSID presence indicator 932, and a short SSID presence indicator 934. The NonTxBSSID information payload 916 may include an optional BSSID 942, an optional short SSID 944, of both. Although only one BSSID and short SSID are shown in FIG. 9, the NonTxBSSID information payload 916 may include multiple BSSIDs and/or short SSIDs.

FIG. 10 depicts an example of an RNR element 470 of an FD frame format that includes discovery information about a Multiple BSSID set. The RNR element 470 includes an element identifier 1010, a length 1012, and neighbor AP information fields 1014. In the traditional RNR element 470, the neighbor AP information fields 1014 includes information about a neighboring AP (including a target beacon transmit time (TBTT) information header 1020, an operating class 1022, a channel number 1024, and a TBTT information set 1026). The TBTT information header 1020 includes a TBTT information field type indicator 1030, a filtered neighbor AP indicator 1032, a TBTT information count indicator 1036, and a TBTT information length indicator 1038). As shown in FIG. 10, the TBTT information header 1020 could be modified to include a NonTxBSSID indicator 1034 that indicates that the TBTT information set 1026 is redefined to include information about a NonTxBSSID.

The traditional TBTT information set 1026 includes a neighbor AP TBTT offset value 1040. In the example of Multiple BSSID Set, the “neighbor AP” (which would be a NonTxBSSID) would not transmit a beacon of its own. Therefore, the TBTT offset value 1040 may be unnecessary. In some implementations, the RNR element 470 may maintain the TBTT offset value 1040 for backward compatibility. In some other implementations, the RNR element 470 may omit the TBTT offset value 1040 when the NonTxBSSID indicator 1034 is set to a first value (such as “1”). The TBTT information set 1026 further includes the optional BSSID 1042 and optional short SSID 1044. The value of the TBTT information length indicator 1038 indicates whether the TBTT information set 1026 includes the optional BSSID 1042 or the optional Short SSID 1044, or both.

In some implementations, the RNR element 470 may be optimized for use with a NonTxBSSID. For example, as described previously, the TBTT offset value 1040 may be omitted because the NonTxBSSID does not transmit a separate beacon (and would not have a neighbor AP TBTT offset time period). Furthermore, because the NonTxBSSID may use the same operating class 1022 and channel number 1024, those fields may be redundant. Therefore, in some implementations, when the NonTxBSSID indicator 1034 is set to the first value, the fields for the operating class 1022 and the channel number 1024 may be omitted.

The examples in this disclosure are related to Multiple BSSID capability in IEEE 802.11. However, some of the techniques may be used with Co-located BSSs, co-hosted BSSs, or the like. For example, the RNR element 470 described in FIG. 10 may be used to signal BSSID or Short SSID information regarding a co-located BSS. A co-located BSS is one that is implemented at the same WLAN apparatus as the first BSS but that signals its own management frames (beacons) separately from the first BSS.

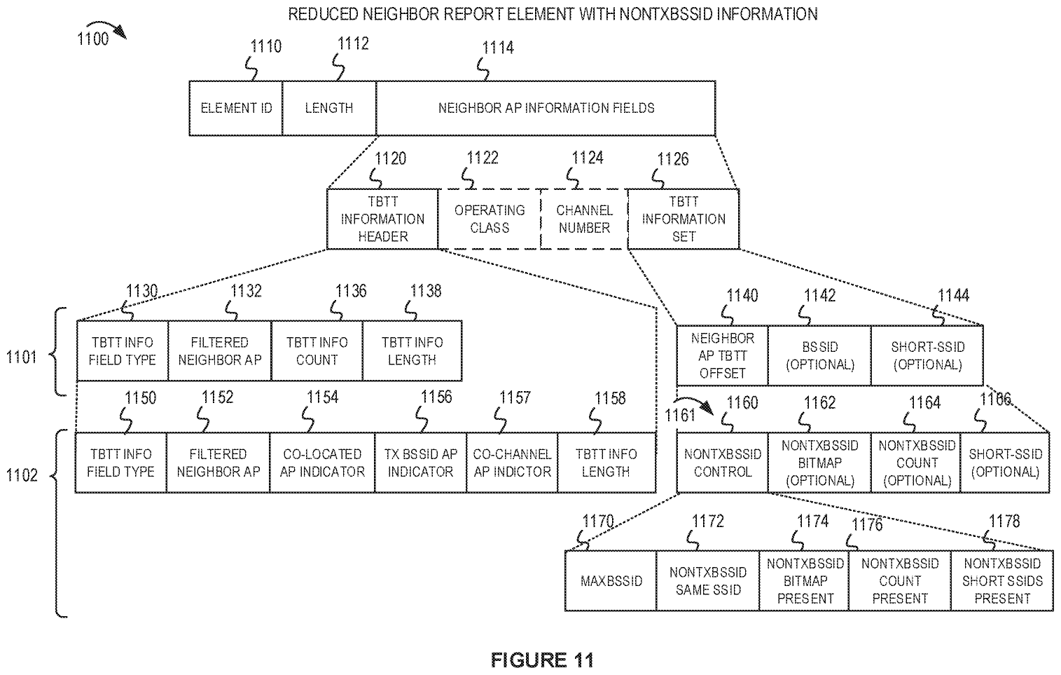

FIG. 11 depicts another example of an RNR element of an FD frame format that includes discovery information about a Multiple BSSID set. The RNR element 1110 includes an element identifier 1110, a length 1112, and neighbor AP information fields 1114. In the traditional RNR element, the neighbor AP information fields 1114 includes information about a neighboring AP. However, in some implementations, the RNR element 1110 may be extended to include information about NonTXBSSIDs in a Multiple BSSID Set. The TBTT information header 1120 includes a TBTT information field type indicator 1130. Depending on the value of the TBTT information field type 1130, the TBTT information header 1120 may have a different format. For example, if the TBTT information field type field 1130 is a first value (such as zero), the TBTT information header 1120 and the TBTT information set 1126 may include a first format 1101 (for a traditional TBTT information set 1126). In the first format 1101, the TBTT information header 1120 also includes a filtered neighbor AP indicator 1132, a TBTT information count indicator 1136, and a TBTT information length indicator 1138. If the TBTT information field type 1130 includes a second value (such as one), the TBTT information header 1120 and the TBTT information set 1126 may have a second format 1102 (such as to include information regarding a Multiple BSSID set). In the second format 1102, the TBTT information header 1120 also includes a filtered neighbor AP indicator 1152, a co-located AP indicator 1154, a TX BSSID AP indicator 1156, a co-channel AP indicator 1157, and a TBTT information length indicator 1158.

The traditional TBTT information set 1126 (for the first format 1101) includes a neighbor AP TBTT offset value 1140, an optional BSSID field 1142 and optional short SSID field 1144. The value of the TBTT information length indicator 1138 indicates whether the TBTT information set 1126 includes the optional BSSID 1142 or the optional Short SSID field 1144, or both.

In the example of Multiple BSSID Set, the “neighbor AP” (which would be a NonTxBSSID) would not transmit a beacon of its own. Therefore, the TBTT offset value 1140 may be unnecessary. Therefore, in some implementations, the RNR element 470 may be optimized for use with a Multiple BSSID Set. For example, as described previously, the TBTT offset value 1140 may be omitted because the NonTxBSSID does not transmit a separate beacon (and would not have a neighbor AP TBTT offset time period). Furthermore, because the NonTxBSSID may use the same operating class 1122 and channel number 1124, those fields may be redundant.

The operating class 1122 is present if the TBTT Information Field Type 1130 is zero, or if the TBTT Information Field Type is one and the co-channel AP indicator 1157 is zero. Otherwise, the operating class 1122 may be omitted from the neighbor AP information fields 1114. The operating class 1122 indicates a channel starting frequency that, together with the channel number 1124, indicates the primary channel of the BSSs of the APs in this Neighbor AP Information field 1114. The channel number 1124 is present if the TBTT information field type indicator 1130 is 0, or if the TBTT information field type indicator 1130 subfield is one and the co-channel AP indicator 1157 is zero. Otherwise, the channel number 1124 may be omitted from the neighbor AP information fields 1114.

The second format 1102 describes how the TBTT information header 1120 and the TBTT information set 1126 may be formatted to include information regarding a Multiple BSSID set. In the second format, the TBTT information header 1120 includes a filtered neighbor AP indicator 1152, a co-located AP indicator 1154, a TX BSSID AP indicator 1156, a co-channel AP indicator 1157, and a TBTT information length indicator 1158. When the TBTT Information Field Type 1150 subfield is set to first value (such as one), it indicates that that all the APs indicated in the TBTT Information Set field are members of the same multiple BSSID set. The co-located AP indicator 1154 is set to a first value (such as one) if every AP in this Neighbor AP Information field 1114 is co-located with the transmitting AP; otherwise, it is set to zero. The TX BSSID AP indicator 1156 is set to a first value (such as one) if the transmitted BSSID of the multiple BSSID set indicated in the TBTT Information Set field is equal to the BSSID of the transmitting AP (the AP sending this Reduced Neighbor Report element); otherwise, it is set to zero. When the TX BSSID AP indicator 1156 is set to one, the co-located AP indicator 1154 and the co-channel AP indicator 1157 are set to one. The co-channel AP indicator 1157 is set to one if the last known primary channel of every AP in this Neighbor AP Information field 1114 is equal to the primary channel of the transmitting AP (the AP sending this Reduced Neighbor Report element); otherwise, it is set to zero.

When the TBTT Information Field Type 1150 is one (referring to the second format 1102) and the TX BSSID AP indicator 1156 subfield is zero, the TBTT Information Set 1126 contains one TBTT Information field (not shown) carrying information on the TxBSSID of the multiple BSSID set, followed by one NonTXBSSID Information field 1161. When the TBTT Information Field Type 1150 is one and the Transmitted BSSID AP subfield is one, the TBTT Information Set 1126 contains one NonTXBSSID Information 1161, as shown in FIG. 11.

The NonTXBSSID Information 1161 includes a NonTXBSSID Control field 1160, an optional NonTXBSSID bitmap 1162, an optional NonTXBSSID count 1164 and an optional short SSID field 1166. Among other things, the NonTXBSSID control field 1160 includes indicators to specify which of the optional NonTXBSSID bitmap 1162, optional NonTXBSSID count 1164 and optional short SSID field 1166 are included in the TBTT information set 1161 (second format 1102). For example, the NonTXBSSID control field 1160 includes a NonTXBSSID Bitmap present indicator 1174, NonTxBSSID Count present indicator 1176, and a NonTxBSSID Short SSIDs present indicator 1178 to indicate whether the TBTT information set 1161 (second format 1102) includes the optional NonTXBSSID bitmap 1162, optional NonTXBSSID count 1164 and optional short SSID field 1166, respectively. When included the optional short SSID field 1166 may include a count of short SSIDs followed by one or more short SSIDs, each representing a different NonTXBSSID.

The NonTXBSSID control field 1160 also includes a Max BSSID field 1170 and a NonTxBSSID Same SSID indicator 1172. The MaxBSSID field 1170 indicates a maximum number of BSSIDs in the Multiple BSSID set. In some implementations, the MaxBSSID field 1170 is equal to a value n minus 1, where n (1<=n<=8) is the value carried in the MaxBSSID Indicator field of a Multiple BSSID element advertised by the TxBSSID of this Multiple BSSID set. For example, a value of zero indicates that the MaxBSSID Indicator value for the multiple BSSID set is one.

The NonTXBSSID Same SSID indicator 1172 is set to a first value (such as one) if any of the NonTXBSSIDs in this Multiple BSSID set have an SSID equal to the SSID of the reporting AP's BSS; otherwise it is set to a second value (such as zero).

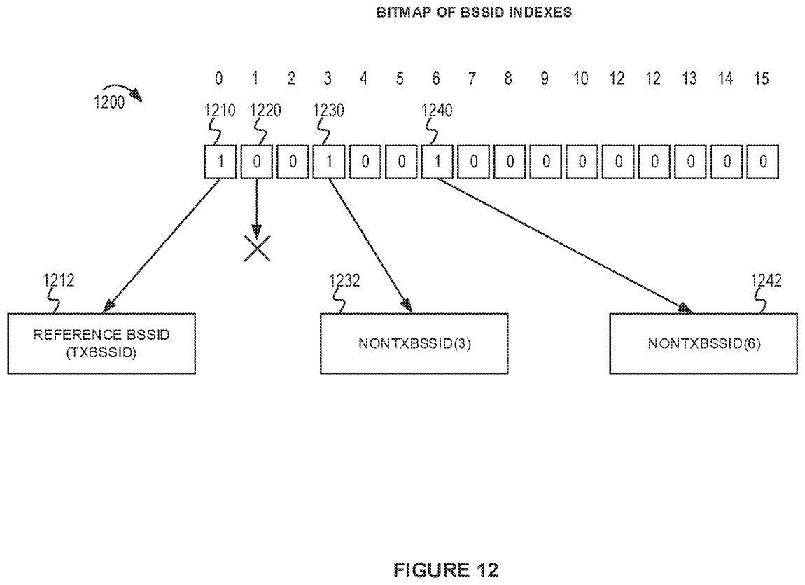

The NonTXBSSID Bitmap field 1162 may include bitmap as described in FIG. 12.

FIG. 12 depicts an example bitmap that indicates both the quantity and index of BSSIDs in a multiple BSSID set. The example bitmap may be used in a new subfield, repurposed field, or a new information element. For example, the example bitmap may be used in the NonTxBSSID information subfield 650 of FIG. 6, the NonTxBSSID information payload 750 of FIG. 7, the NonTxBSSID information payload 1016 of FIG. 10, the optional NonTXBSSID bitmap 1162 of FIG. 11, or the like. In some implementations, the bitmap index of FIG. 12 may be used to represent which BSSs of a Multiple BSSID set are being hosted at the WLAN apparatus. For example, a STA may be capable of using the bitmap index and a TxBSSID to determine a list of BSSIDS associated with the Multiple BSSID set.

The bitmap 1200 may include a fixed quantity or a variable quantity of bits. For example, the TBTT information header 1120 may have a length of 2n bits where n is equal to the value of the MaxBSSID 1170 plus 1, In some implementations a first bit (bit position 0) is reserved. The remainder of the bits represents one of 2n−1 possible BSSID Index values in the multiple BSSID set. A value of 1 at bit position k indicates that a NonTXBSSID with BSSID Index k is a member of the indicated Multiple BSSID set. Otherwise the bit is set to 0. The TBTT information header 1120 may be padded with additional bits set to 0 to make the total number of bits in the bitmap 1200 equal to an integer number of octets.

In the example bitmap 1200 shown in FIG. 12, the bitmap 1200 includes sixteen-bit positions (numbered 0 to 15). For example, if the WLAN Apparatus signals a MaxBSSID Indicator is 4, then there are 16 (2\hat{ }4) possible BSSs that the WLAN apparatus may operate. However, the WLAN apparatus may not operate all 16. In the example of FIG. 12, the WLAN apparatus is currently operating three (3) BSSs in the Multiple BSSID set. A first value (one, 1) in each of the bit positions associated with bit position 0 (box 1210), bit position 3 (box 1230), and bit position 6 (box 1240) indicates that there are BSSs associated with each of those bit positions. A second value (zero, 0) in the other bit positions (such as box 1220) indicates that the WLAN apparatus is not operating a BSS associated with that bit position. Thus, by counting the quantity of is in the bitmap, the receiving STA may quickly determine a total quantity of BSSs that belong to the Multiple BSSID Set. Although the examples in this disclosure use ones (1s) and zeros (0s) for the first value and second value, a standard specification may define different values for the first value and second value. Furthermore, although the example in Figure shows the bitmap index value increasing from left to right, in other implementations, the bitmap index value may begin from the right and increase index value from right to left.

The index value also may inform the receiving STA regarding an address (such as a MAC address) of each BSSID in the Multiple BSSID set. For example, the index value 0 (associated with box 1210) may correlate to the reference BSSID (transmitted BSSID, or TxBSSID) of the WLAN apparatus. The TxBSSID is the BSSID that is indicated in the header of the management frame as the sending address for the management frame that aggregates information about the Multiple BSSID set. The reference address (which also may be referred to as a base address) of the Multiple BSSID Set may be determined by the STA by observing the address of the TxBSSID in the header of the management frame. The first value in box 1230 is associated with an index value of 3. Therefore, the address NonTxBSSID for that BSS may be determined by adding the integer value of “3” to the numeric representation of the base address for the Multiple BSSID set. In some implementations, the STA may convert the base address from a first MAC address to a first numeric representation before adding the integer index value to the first numeric representation. The sum of the first numeric representation and the integer index value may be a second numeric representation. The second numeric representation may be converted to a second MAC address that represents the NonTxBSSID of another BSS in the Multiple BSSID set. The index value may be used as shorthand to represent the address of each NonTxBSSID in the Multiple BSSID set. For example, NonTxBSSID (3) (for index value 3 represented by box 1230) indicates that the Multiple BSSID set includes a BSS having an address that is an integer 3 value higher than the base address. Similarly, NonTxBSSID (6) (for index value 6 represented by box 1240) indicates that the Multiple BSSID set includes a BSS having an address that is an integer 6 value higher than the base address.

Although FIGS. 5-12 describe some examples of how an FD frame may communicate discovery information related to a Multiple BSSID set, there may be other example implementations. For example, a wireless communication standard may define the formatting of discovery frames. An FD frame may be formatted to carry different information elements. In some implementations, an existing information element may be modified to include a new field for the discovery information. In another example, a new sub-element may be defined for the discovery information. In some implementations, an existing field may be repurposed to carry the discovery information. For example, a reserved field or a field that is deprecated or not applicable in the communication system may be repurposed to in the wireless communication standard so that the existing field may be defined for the new purpose of carrying the discovery information. In another example implementation, a new information element may be defined to convey the discovery information.

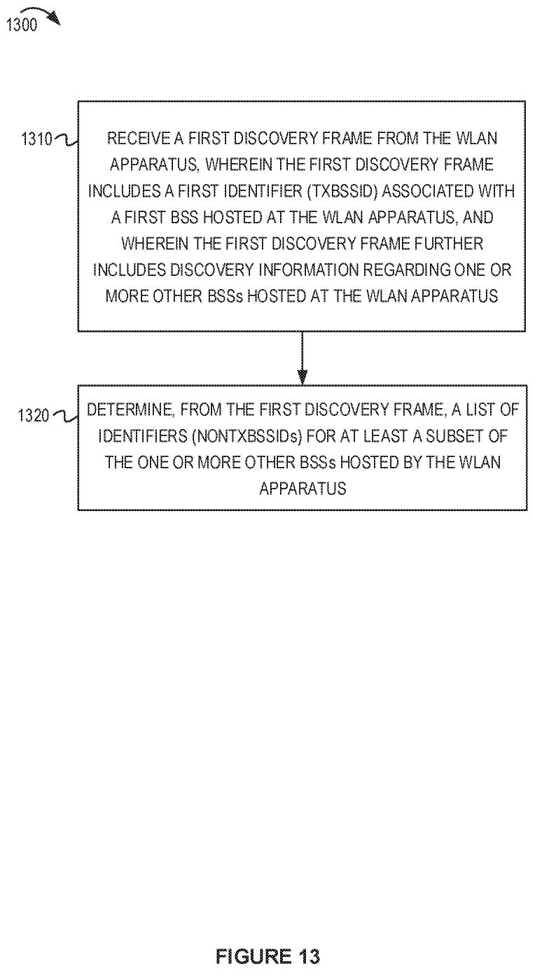

FIG. 13 depicts an example flowchart for a STA receiving a discovery frame that includes discovery information regarding multiple BSSIDs. The flowchart 1300 begins at block 1310. At block 1310, the STA may receive a first discovery frame from the WLAN apparatus. The first discovery frame may include a first identifier (TxBSSID) associated with a first BSS hosted at the WLAN apparatus. The first discovery frame further includes discovery information regarding one or more other BSSs hosted at the WLAN apparatus. For example, the first discovery frame may be an FD frame that conforms to a FILS protocol of the WLAN. The discovery information may include identifiers associated with one or more other BSSs of a Multiple BSSID set. For example, the identifiers may be a BSSID, SSID, or Short SSID associated with a NonTxBSSID.

At block 1320, the STA may obtain, from the first management frame, a list of identifiers for at least a subset of one or more other BSSs hosted by the WLAN apparatus. At block 1330, the STA may determine, from the first discovery frame, a list of identifiers (NonTxBSSIDs) for at least a subset of the one or more other BSSs hosted by the WLAN apparatus.

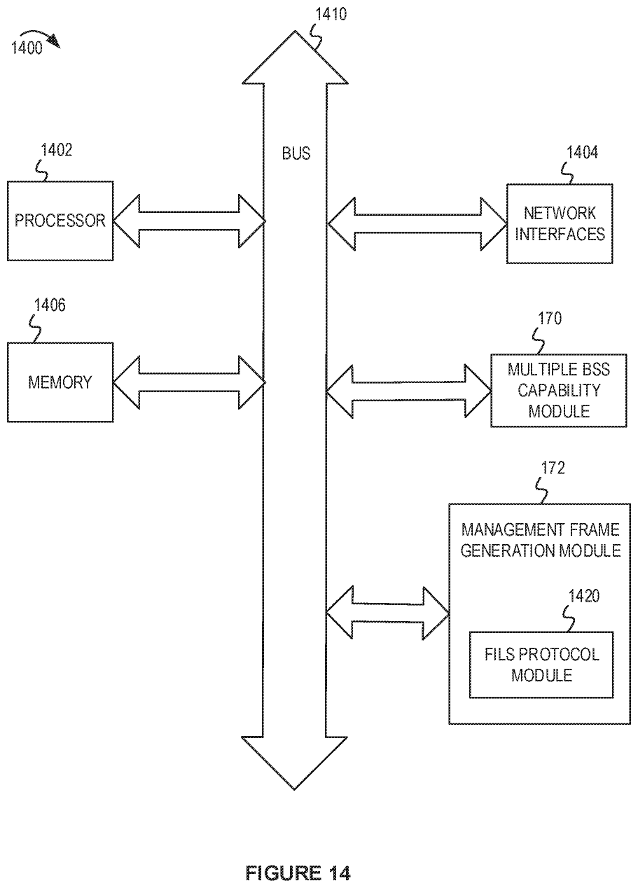

FIG. 14 shows a block diagram of an example electronic device for implementing aspects of this disclosure. In some implementations, the electronic device 1400 may be an access point (including any of the APs described herein), a range extender, or other electronic systems. The electronic device 1400 can include a processor unit 1402 (possibly including multiple processors, multiple cores, multiple nodes, or implementing multi-threading, etc.). The electronic device 1400 also can include a memory unit 1406. The memory unit 1406 may be system memory or any one or more of the possible realizations of computer-readable media described herein. The electronic device 1400 also can include a bus 1410 (such as PCI, ISA, PCI-Express, HyperTransport®, InfiniBand®, NuBus,® AHB, AXI, etc.), and a network interface 1404 that can include at least one of a wireless network interface (such as a WLAN interface, a Bluetooth® interface, a WiMAX® interface, a ZigBee® interface, a Wireless USB interface, etc.) and a wired network interface (such as an Ethernet interface, a powerline communication interface, etc.). In some implementations, the electronic device 1400 may support multiple network interfaces—each of which is configured to couple the electronic device 1400 to a different communication network.

The electronic device 1400 may include a Multiple BSS Capability module 170 and a management frame generation module 172, similar to those described in FIG. 1. In some implementations, the Multiple BSS Capability module 170 and the management frame generation module 172 can be distributed within the processor unit 1402, the memory unit 1406, and the bus 1410.

The memory unit 1406 can include computer instructions executable by the processor unit 1402 to implement the functionality of the implementations described in FIGS. 1-13. Any one of these functionalities may be partially (or entirely) implemented in hardware or on the processor unit 1402. For example, the functionality may be implemented with an application specific integrated circuit, in logic implemented in the processor unit 1402, in a co-processor on a peripheral device or card, etc. Further, realizations may include fewer or additional components not illustrated in FIG. 14 (such as video cards, audio cards, additional network interfaces, peripheral devices, etc.). The processor unit 1402, the memory unit 1406, and the network interface 1404 are coupled to the bus 1410. Although illustrated as being coupled to the bus 1410, the memory unit 1406 may be coupled to the processor unit 1402.

FIGS. 1-14 and the operations described herein are examples meant to aid in understanding example implementations and should not be used to limit the potential implementations or limit the scope of the claims. Some implementations may perform additional operations, fewer operations, operations in parallel or in a different order, and some operations differently.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described throughout. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module that may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray′ disc where disks usually reproduce data magnetically, while discs reproduce data optically with lasers. Combinations also can be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. A method performed by a wireless local area network (WLAN) apparatus, comprising:
operating multiple basic service sets (BSSs) at the WLAN apparatus, wherein each of the BSSs are identified by BSS identifiers (BSSIDs) and collectively the multiple BSSs form a Multiple BSSID Set, wherein a first BSS is identified as a transmitting BSSID (TxBSSID) of the Multiple BSSID Set and is configured to transmit one or more management frames that include elements for other BSSs of the Multiple BSSID Set, the other BSSs each identified as a non-transmitting BSSID (NonTxBSSID); and
transmitting a first discovery report via the first BSS, wherein the first discovery report includes discovery information regarding at least one NonTxBSSID of the Multiple BSSID Set.

2. The method of claim 1,
wherein the multiple BSSs of the Multiple BSSID Set use a common operating class, channel, channel access function, and antenna connector at the WLAN apparatus, and
wherein the multiple BSSs are identified by BSSIDs that have a common portion.

3. The method of claim 1, wherein the first discovery report includes the TxBSSID of the first BSS as a source of the first discovery report, and wherein the first discovery report includes NonTxBSSIDs for each of the other BSSIDs in the Multiple BSSID Set.

4. The method of claim 1, wherein the first discovery report includes a first set of NonTxBSSIDs of the Multiple BSSID Set, the method further comprising:
transmitting a second discovery report via the first VAP, wherein the second discovery report includes a second set of NonTxBSSIDs of the Multiple BSSID Set.

5. The method of claim 1, wherein the first discovery report is included in an information element of a fast-initial link setup (FILS) discovery (FD) frame defined for a FILS protocol.

6. The method of claim 1, wherein the first discovery report is included in a reduced neighbor report (RNR) element of a management frame.

7. The method of claim 5, wherein the RNR element is included in a fast-initial link setup (FILS) discovery (FD) frame that conforms to a FILS protocol of the WLAN, a Beacon frame, or Probe Response frame.

8. The method of claim 6, wherein the RNR element includes a first field to indicate a format of the RNR element, wherein the first field is populated with a first value when the RNR element is formatted with a first format to include information regarding a neighbor AP, and, wherein the first field is populated with a second value when the RNR element is formatted with a second format to include information regarding the Multiple BSSID Set.

9. The method of claim 8, wherein the first format and the second format include different field definitions for one or more other fields in the RNR element.

10. The method of claim 1, wherein the first discovery report includes an indicator to whether the discovery information includes a complete list or a partial list of NonTXBSSIDs in the Multiple BSSID Set.

11. The method of claim 1, wherein the first discovery report includes at least one short service set identifier (Short SSID), the Short SSID being a fixed length hash of a service set identifier (SSID).

12. The method of claim 1, wherein the discovery information includes a count of the multiple BSSs associated with a Multiple BSSID Set.

13. The method of claim 1, wherein the discovery information includes a bitmap index that represents which BSSs of a Multiple BSSID Set are being hosted at the WLAN apparatus.

14. The method of claim 13, wherein the bitmap index and a BSS identifier (BSSID) are usable by a station (STA) to determine a list of BSSIDS associated with the Multiple BSSID Set.

15. The method of claim 1, wherein the first discovery report includes a maximum basic service set identifier (MaxBSSID) indicator associated with the Multiple BSSID Set the MaxBSSID indicator for indicating a maximum quantity of BSSIDs in the Multiple BSSID Set.

16. A method performed by a station (STA) for communicating with a wireless local area network (WLAN) apparatus, comprising:
receiving a first discovery report from the WLAN apparatus that operates multiple basic service sets (BSSs), wherein each of the BSSs are identified by BSS identifiers (BSSIDs) and collectively the multiple BSSs form a Multiple BSSID Set, wherein a first BSS is identified as a transmitting BSSID (TxBSSID) of the Multiple BSSID Set, the other BSSs each identified by a non-transmitting BSSID (NonTxBSSID);
obtaining, from the first discovery report, discovery information regarding one or more other BSSs in the Multiple BSSID Set; and
determining, from the discovery information, a list of (NonTxBSSIDs for at least a subset of the one or more other BSSs hosted by the WLAN apparatus.

17. The method of claim 16, wherein the first discovery report is included in a reduced neighbor report (RNR) element of a management frame.

18. The method of claim 17, wherein the RNR element is included in a fast-initial link setup (FILS) discovery (FD) frame that conforms to a FILS protocol of the WLAN, a Beacon frame, or Probe Response frame.

19. The method of claim 17, wherein the RNR element includes a first field to indicate a format of the RNR element, wherein the first field is populated with a first value when the RNR element is formatted with a first format to include information regarding a neighbor AP, and, wherein the first field is populated with a second value when the RNR element is formatted with a second format to include information regarding the Multiple BSSID Set.

20. The method of claim 19, wherein the first format and the second format include different field definitions for one or more other fields in the RNR element.

21. The method of claim 16, wherein the first discovery report includes at least one short service set identifier (Short SSID), the Short SSID being a fixed length hash of a service set identifier (SSID).

22. The method of claim 16, wherein the discovery information includes a count of the multiple BSSs associated with a Multiple BSSID Set.

23. The method of claim 16, wherein the discovery information includes a bitmap index that represents which BSSs of a Multiple BSSID Set are being hosted at the WLAN apparatus.

24. The method of claim 16, wherein the bitmap index and a BSS identifier (BSSID) are usable by a station (STA) to determine a list of BSSIDS associated with the Multiple BSSID Set.

25. A wireless communication device for use in a wireless local area network (WLAN) apparatus, comprising:
at least one modem;
at least one processor communicatively coupled with the at least one modem; and
at least one memory communicatively coupled with the at least one processor and storing processor-readable code that, when executed by the at least one processor in conjunction with the at least one modem, is configured to:
operate multiple basic service sets (BSSs) at the WLAN apparatus, wherein each of the BSSs are identified by BSS identifiers (BSSIDs) and collectively the multiple BSSs form a Multiple BSSID Set, wherein a first BSS is identified as a transmitting BSSID (TxBSSID) of the Multiple BSSID Set and is configured to transmit one or more management frames that include elements for other BSSs of the Multiple BSSID Set, the other BSSs each identified as a non-transmitting BSSID (NonTxBSSID); and
transmit a first discovery report via the first BSS, wherein the first discovery report includes discovery information regarding at least one NonTxBSSID of the Multiple BSSID Set.

26-29. (canceled)

30. The wireless communication device of claim 25, wherein the first discovery report is included in a reduced neighbor report (RNR) element of a management frame.

31. The wireless communication device of claim 30, wherein the RNR element is included in a fast initial link setup (FILS) discovery (FD) frame that conforms to a FILS protocol of the WLAN, a Beacon frame, or Probe Response frame.

32. The wireless communication device of claim 30, wherein the RNR element includes a first field to indicate a format of the RNR element, wherein the first field is populated with a first value when the RNR element is formatted with a first format to include information regarding a neighbor AP, and, wherein the first field is populated with a second value when the RNR element is formatted with a second format to include information regarding the Multiple BSSID Set.

33-35. (canceled)

36. The wireless communication device of claim 25, wherein the discovery information includes a bitmap index that represents which BSSs of a Multiple BSSID Set are being hosted at the WLAN apparatus, and wherein the bitmap index is usable by a station (STA) to determine a list of BSSIDS associated with the Multiple BSSID Set.

37-38. (canceled)

39. A wireless local area network (WLAN) apparatus comprising:
a wireless communication device comprising:
at least one modem;
at least one processor communicatively coupled with the at least one modem; and
at least one memory communicatively coupled with the at least one processor and storing processor-readable code that, when executed by the at least one processor in conjunction with the at least one modem, is configured to:
operate multiple basic service sets (BSSs) at the WLAN apparatus, wherein each of the BSSs are identified by BSS identifiers (BSSIDs) and collectively the multiple BSSs form a Multiple BSSID Set, wherein a first BSS is identified as a transmitting BSSID (TxBSSID) of the Multiple BSSID Set and is configured to transmit one or more management frames that include elements for other BSSs of the Multiple BSSID Set, the other BSSs each identified as a non-transmitting BSSID (NonTxBSSID); and
transmit a first discovery report via the first BSS, wherein the first discovery report includes discovery information regarding at least one NonTxBSSID of the Multiple BSSID Set;
at least one transceiver coupled to the at least one modem;
at least one antenna coupled to the at least one transceiver to wirelessly transmit signals output from the at least one transceiver and to wirelessly receive signals for input into the at least one transceiver; and
a housing that encompasses the at least one modem, the at least one processor, the at least one memory, the at least one transceiver and at least a portion of the at least one antenna.

40-53. (canceled)
